(19) United States
(12) Patent Application Publication
(10) Pub. No.: US 2010/0080431 A1
(43) Pub. Date: Apr. 1, 2010

(54) SMART PATIENT-MONITORING CHAIR

(75) Inventors: Cornelis Pauwel Datema, Best (NL); Laszlo Herczegh, Eindhoven (NL); Stephen Robert Heath, Andover, MA (US); Sachin Behere, Andover, MA (US); Lesh Parameswaran, Eindhoven (NL); George Marmaropoulos, Valhalla, NY (US); Fritz Winderl, Highland Heights, OH (US); Jennifer Bryniarski, Highland Heights, OH (US); Dawn Marie Maniawski, Highland Heights, OH (US); Estelle Hilas, Highland Heights, OH (US); Julianne Suhy, Highland Heights, OH (US)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/515,442

(22) PCT Filed: Nov. 26, 2007
(86) PCT No.: PCT/IB07/54778

§ 371 Date: May 19, 2009

(30) Foreign Application Priority Data
Nov. 24, 2006 (EP) 06124770.6

(51) Int. Cl. G06K 9/00; A47B 13/00

(52) U.S. Cl. 382/131; 5/601

(57) ABSTRACT

A patient carrier is hereby proposed for use in a radiation imaging suite, the patient carrier comprising at least one sensor configured to detect one or more parameters in a group of environmental parameters in the radiation imaging suite and physiological parameters of a patient positioned on the patient carrier, and an event initiator arranged to initiate an event in the radiation imaging suite based on the one or more detected parameters.

### FIELD OF THE INVENTION

The invention relates to the field of radiation imaging, and particularly to patient carriers used in radiation imaging environments.

### BACKGROUND OF THE INVENTION

X-ray computed tomography (CT) and/or positron emission tomography (PET) examinations can take a fairly long time. For example, as mentioned in a report of the American Association of Physicists in Medicine in the journal Medical Physics entitled “AAPM Task Group 108: PET and PET/CT Shielding Requirements”, Volume 3, Issue 1, pp. 4-15, January 2006, PET images are acquired at 6 to 10 bed positions over a 15 to 60 minute interval.

It is also mentioned in the report that for some PET procedures, patients have to wait for a certain period of time after the administration of a radiopharmaceutical for the radiopharmaceutical to distribute itself in their body. During this waiting period, also called the uptake period, the patient has to minimize movement so as to reduce uptake of the radiopharmaceutical into the skeletal muscles.

It is also mentioned in the report that staff at PET imaging facilities (also called caregivers herein) should develop measures to minimize time spent near patients after the patients have been administered a radiopharmaceutical, in order to minimize radiation exposure to the caregiver. The report suggests remote monitoring of patients using video cameras as a means to achieve this.

### SUMMARY OF THE INVENTION

Staying still (i.e., without voluntary physical movement) during a scanning procedure lasting 15 minutes or more is not easy for many patients and especially difficult for children. However, excessive movement could lead to severe degradation in image quality, sometimes necessitating a repeat scan leading to increased radiation exposure to the patient. Furthermore, as mentioned above, in PET or combined PET-CT examinations, patients may have to stay still during the uptake period, which could be as long as 90 minutes.

In a non-radioactive environment, it is possible for a care-giver, for example, a doctor, nurse or technician, to monitor the patient in close physical proximity to ensure that the patient does not move much during the uptake period or during the imaging procedure; however, in a radiation imaging procedure such as a PET scan or a gamma scan, this is better done remotely.

Thus there is a need to remotely monitor patients in a radiation imaging suite after administration of a radiopharmaceutical, both during the uptake period and during imaging. Furthermore, there is also a need for a method of remotely monitoring such a patient as well as a computer program to implement such a method in a radiation imaging suite.

Accordingly, a patient carrier is hereby proposed for use in a radiation imaging suite, the patient carrier comprising at least one sensor configured to detect one or more parameters in a group of environmental parameters in the radiation imaging suite and physiological parameters of a patient positioned on the patient carrier, and an event initiator arranged to initiate an event in the radiation imaging suite based on the one or more detected parameters.

The patient carrier has one or more integrated sensors that monitor a variety of environmental and physiological parameters like ambient noise, light and temperature levels, patient respiratory and cardiac rates, movements of limbs or other parts of the patient's body, patient's body temperature, skin moisture levels, etc. When an abnormal condition is detected, for example, an unanticipated movement of the patient's body or a change in body temperature, etc., an event initiator linked to the patient carrier initiates an appropriate and corresponding event, for example, playing a recorded audio and/or video clipping prompting the patient to lie still, adjusting the ambient temperature to a more comfortable level, etc.

Furthermore, a method of initiating an event in a radiation imaging suite by a patient carrier is also disclosed herein, wherein the patient carrier comprises at least one sensor, and wherein the method comprises detecting, using the at least one sensor, one or more parameters in a group of environmental parameters in the radiation imaging suite and physiological parameters of a patient positioned on the patient carrier, and initiating an event in the radiation imaging suite based on the one or more detected parameters.

Furthermore, a computer program to enable a patient carrier to initiate an event in a radiation imaging suite is also disclosed herein, wherein the patient carrier comprises at least one sensor, and wherein the computer program comprises instructions to detect, using the at least one sensor, one or more parameters in a group of environmental parameters in the radiation imaging suite and physiological parameters of a patient positioned on the patient carrier, and initiate an event in the radiation imaging suite based on the one or more detected parameters, when the computer program is run on a computer.

### BRIEF DESCRIPTION OF THE DRAWINGS

These and other aspects will be described in detail hereinafter, by way of example, on the basis of the following embodiments, with reference to the accompanying drawings, wherein:

FIG. 1 shows an embodiment of the patient carrier disclosed herein being used in an uptake room in a PET facility;

FIG. 2 shows an embodiment of the patient carrier disclosed herein being used in a waiting room of a radiation imaging facility;

FIG. 3 shows an embodiment of the patient carrier disclosed herein being used inside a scanning room; and

FIG. 4 shows a control system that is capable of implementing the method of initiating an event in a radiation imaging suite by a patient carrier as disclosed herein.

Corresponding reference numerals when used in the various figures represent corresponding elements in the figures.

### DETAILED DESCRIPTION OF EMBODIMENTS

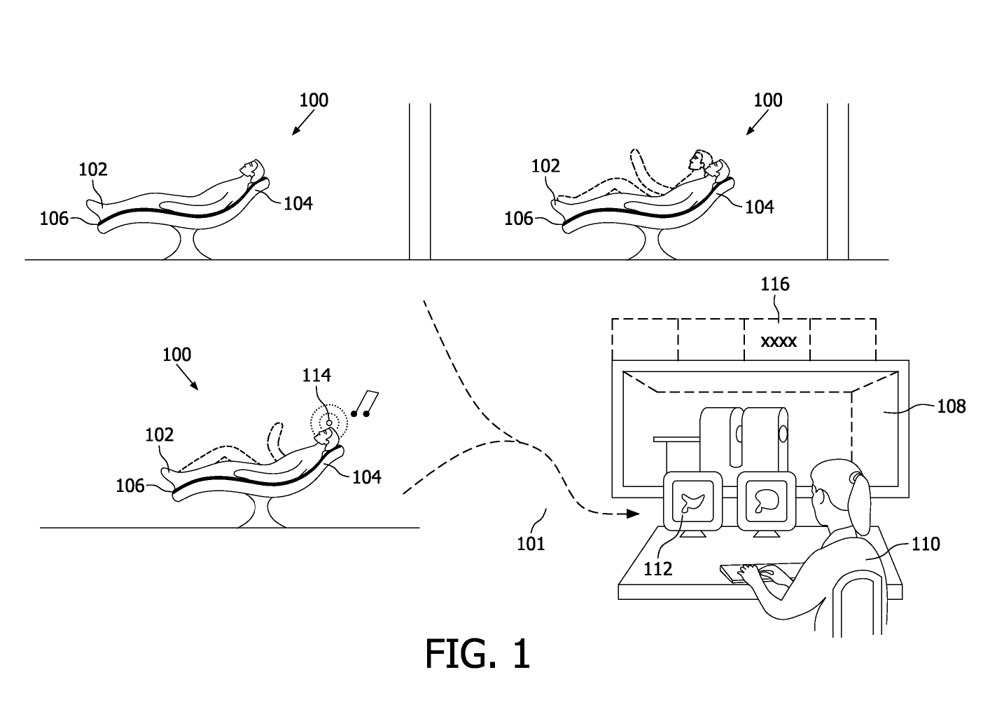

FIG. 1 shows an embodiment of the patient carrier being used in an uptake room 100 in a PET facility. A patient 102 has been injected with a radiopharmaceutical and is waiting for the radiopharmaceutical to get distributed in his body. During this period, he is positioned on a patient carrier 104, for example a relaxation chair, that comprises one or more sensors 106 embedded into the patient carrier 104. When the sensors 106 detect movement of the patient 102, an audio trigger or alarm 114 is initiated in the uptake room 100. Simultaneously, a caregiver 110 stationed in a console room 101 and engaged in conducting another procedure in a scanning room 108 is alerted of the movement of the patient 102 in the uptake room 100 by a visual indicator 116.

During the uptake period (i.e., the waiting period after the patient has been injected with a radiopharmaceutical), the patient has to remain still (i.e., without voluntary physical movement) in order to minimize uptake of the radiopharmaceutical into skeletal muscles. Thus one of the physiological parameters that may be monitored is movement of the patient. To measure this, the sensors embedded in the relaxation chair may consist of vibration sensors (e.g., accelerometers) that detect motion of the patient 102 by measuring the vibrations induced by such movement. Alternatively, the sensors could be weight sensors that detect changes in the weight distribution on the relaxation chair, and thereby deduce the amount of movement. Other sensors could detect cardiac or respiratory rates of the patient. Abnormalities detected in the detected parameters could signify movement or a potential for movement. For example, if the heart rate increases significantly, it might be an indication that the patient is getting agitated, which could in turn increase the chances of the patient moving in the patient carrier.

The information collected by the sensors in the relaxation chair may be used to initiate events such as audiovisual triggers that could serve to both warn the patient that he is moving, as well as to calm him down so that further movement is minimized. For example, an audible beep could first sound as a warning to the patient that he is moving, following which some soothing music or natural sounds like the chirping of birds or the sounds of a flowing stream could be played to calm the patient.

Simultaneously, the relaxation chair could notify a caregiver at a remote location that the patient has moved. Thus the caregiver can remotely monitor the patient in the relaxation chair. This is specifically useful for the PET-CT environment where a patient injected with a radiopharmaceutical needs to lie/sit still in a dark room that should not be accessed by staff due to radiation hazards. For such monitoring from a remote location, the relaxation chair may need to be equipped with a transmitter that transmits a control signal to a receiver located in the remote location. The transmitter could communicate wirelessly or over conducting wires with the receiver in the remote location.

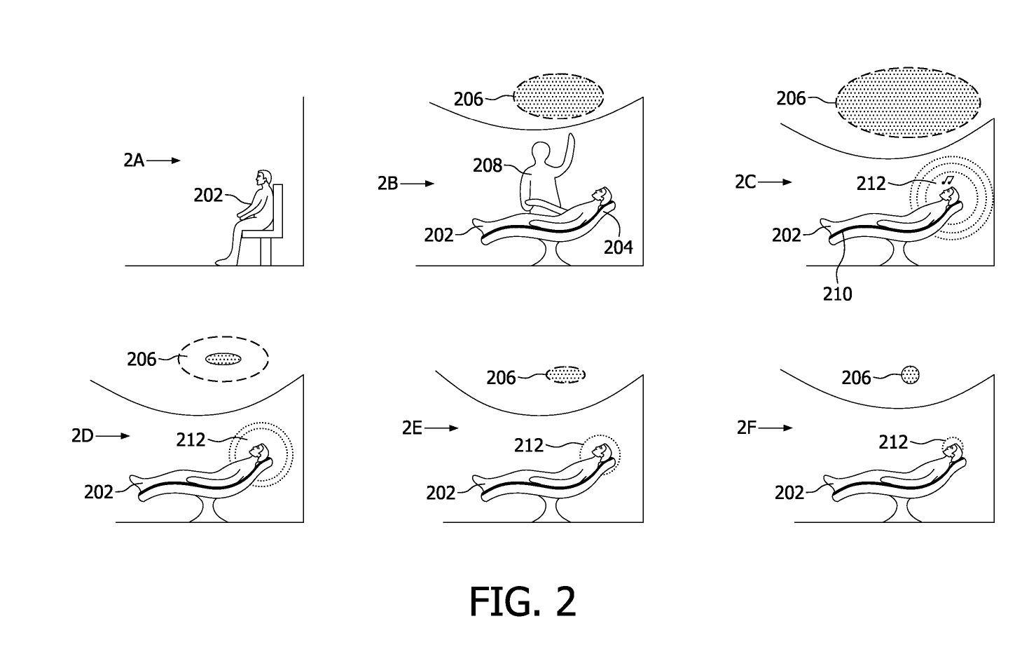

FIG. 2 shows an embodiment of the patient carrier being used in an uptake room of a PET facility. Healthcare institutions usually have dedicated rooms in which the patient is requested to wait for some period of time. For example, in a PET facility, the patient may have to wait for up to one and a half hours in a special waiting room to enable proper uptake of an injected radiopharmaceutical. Waiting rooms that serve such a purpose are often called uptake rooms and the waiting period spent inside the uptake room is often called the uptake period. In picture 2A, a patient 202 is shown waiting in an uptake room. In picture 2B, the patient 202 is positioned in a patient carrier 204, for example a relaxation chair, inside the uptake room, while a caregiver 208 draws the attention of the patient 202 to a graphical display 206 projected on the ceiling. Sensors 210 embedded into the patient carrier enable the patient carrier to detect one or more physiological parameters of the patient, one or more environmental parameters in the uptake room, or a combination of the two. As shown successively in pictures 2B, 2C, 2D, 2E and 2F, the graphical display 206 changes in size (or some other parameter) based on changes in certain parameters detected by the relaxation chair.

By choosing the graphical display properly, it is possible to induce a sense of calm in the patient. For example, the graphical display could show a natural scene that is typically connected with a tranquil environment, like a flower-covered mountain meadow. Alternatively, the graphical display could periodically change a parameter, for example its size or colour. By instructing the patient to breathe deeply in synchrony with the changing graphical display (for instance, inhale when the graphic is increasing in size and exhale when it is decreasing in size), a sense of calm could be induced in the patient. Additionally, the relaxation chair could monitor the respiration of the patient; if the patient's breathing is not in synchrony with the dynamic graphical display, the relaxation chair could initiate an alert to either the patient or the caregiver or both. If the patient is awake, he could adjust his breathing accordingly. However, in case the relaxation chair senses that the patient does not synchronize his breathing for a set period of time, the caregiver could be alerted via an audio or visual (or audiovisual) signal, so that the caregiver could immediately determine if the patient is simply asleep or having some trouble breathing.

The caregiver may set lower and upper limits for certain parameters measured, for example the patient's heart, respiratory rate or movement. When the sensed parameter exceeds the set limits, as could happen during excessive movement of the patient, the patient carrier either provides direct feedback to the patient, or the caregiver is alerted, who could then instruct the patient to lay still. Similarly, in the case that the monitored heart rate drops to zero, it could mean that the patient has left the chair, in which case the caregiver could instruct the patient to return to the chair. In any case, it is imperative that the caregiver be immediately alerted when the heart rate or respiratory rate as sensed by the relaxation chair falls to zero, as it could imply a more serious clinical situation requiring immediate attention from the caregiver. Thus the relaxation chair as disclosed herein makes patient monitoring more reliable and increases the efficiency of the caregiver staff by drawing their attention quickly to a potential problem.

It may be noted that a sound trigger 212 (i.e., an audio indicator) like a beep that changes in volume or a song that changes in tempo may be used instead of a visual trigger 206. It is also possible to use a combination of audio and visual indicators, as shown in picture 2C. Similar audio, visual or combined triggers may also be used in patient recovery rooms, while a patient is in a post-operative recovery stage or in other areas where patients have to wait before or after a medical procedure.

It may also be noted that a patient carrier as disclosed herein could be used in other types of waiting rooms as well, for example a holding area where the patient is monitored while recovering from anesthesia or a recovery room where a patient is monitored after a cardiac stress test. Under these (and other similar) circumstances, it might be useful to monitor certain physiological parameters like the heart rate or respiratory rate, which at times could indicate the recovery level of the patient. Thus, if a patient recovers faster, there would be no need to retain him/her in the recovery room, and the procedure could therefore be expedited.

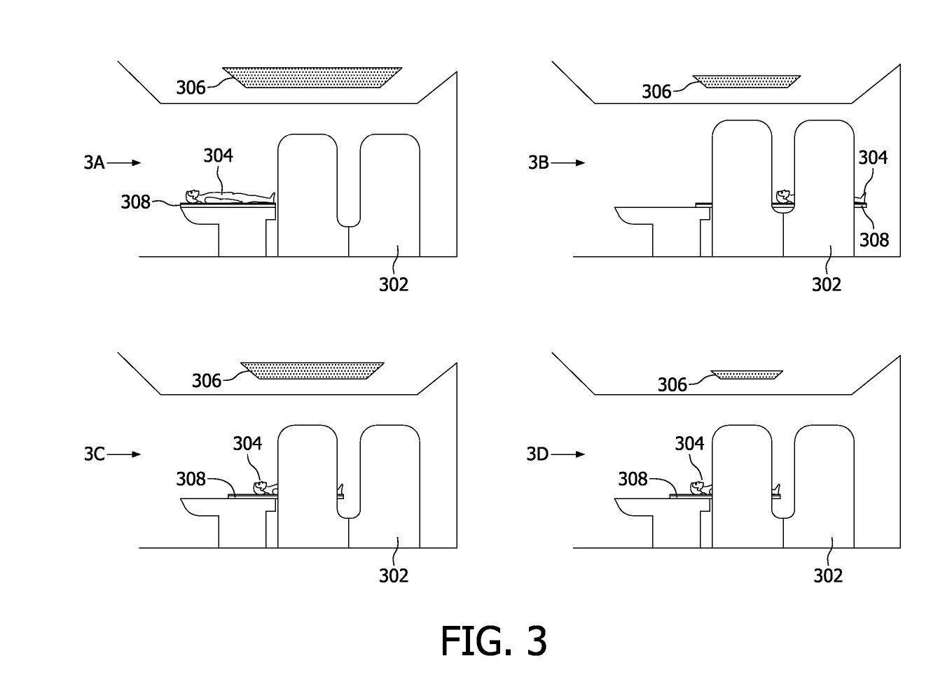

FIG. 3 shows an embodiment of the patient carrier disclosed herein being used inside a scanning room. In picture 3A, a patient 304 is placed on the patient carrier, for example a patient table 308. The patient 304 is moved into a scanner 302 in picture 3B and imaging is initiated. Some indication of the procedure, or other graphic designed to induce a sense of calm in the patient, is displayed graphically on the ceiling of the imaging room, as shown by the graphic 306 in successive pictures 3A, 3B, 3C and 3D.

The patient table 308 may have embedded motion or vibration sensors (not shown) that continuously monitor the patient for motion. As excessive motion could degrade image quality and reduce its diagnostic value, the patient needs to be warned when such motion occurs. An effective way of doing this is to suddenly change the graphic projected on the ceiling, thereby catching the patient's attention. Thus the initiated event would be a change in the size or color of the graphic. For example, if the time remaining for the procedure is being displayed as a circle of proportionate size on the ceiling, and the patient is watching it in anticipation of the end of the procedure, a sudden increase in the size of the graphic and/or a change to red color could warn the patient to hold still, as otherwise it would take longer for the procedure to end. Thus, the graphic could provide an incentive for the patient to hold still and thereby increase the pace of progress of the scan. Of course, the graphic could be any other representative figure, for example, a “smiley face” cartoon that changes to a “frowning face” when excessive motion is detected. Such visual indicators of facial expressions are quite powerful in conveying messages, and may work especially well in the case of children.

While it is a fact that the patient often needs to hold as still as possible during a scan, it is also often the case that patients should not relax so much that they go to sleep. This could be for a number of reasons like the need to respond to a caregiver's instructions (for example, to hold one's breath during a scan) or due to the fact that involuntary movements that occur naturally during sleep cannot be controlled. To prevent the patient from going to sleep, the graphic 306 could be made more interesting, for example by displaying a movie or news clipping or an animated cartoon, etc., combined with the appropriate soundtrack. Of course, instead of the visual or audiovisual triggers mentioned above, simple audio triggers could also be used, for example a voice that suddenly requests the patient to hold still when excessive patient motion is detected by the patient table.

Thus, the patient carrier helps to relax the patient through events that are initiated by the patient carrier in response to physiological or environmental parameters detected by sensors linked to the patient carrier. Relaxing the patient in this way during a scan will result in better diagnostic results. Secondly, the automatic monitoring performed by the patient carrier relieves the caregivers from manually monitoring patients, which will improve staff efficiency and reduce the chance of mistakes.

It may be noted that the patient relaxation chair and patient table discussed above are only exemplary embodiments of the patient carrier disclosed herein. The concept may be extended to wherever regular, non-invasive monitoring of patients is required, for example in an ambulance stretcher or hospital bed, etc. The patient carrier could be embedded with sensors directly on its surface. It is also possible that the sensors are embedded in a mattress or a sheet that is laid on top of a patient chair or table; under this circumstance, the combination of the mattress/sheet and patient table/chair is to be taken to represent the patient carrier discussed herein.

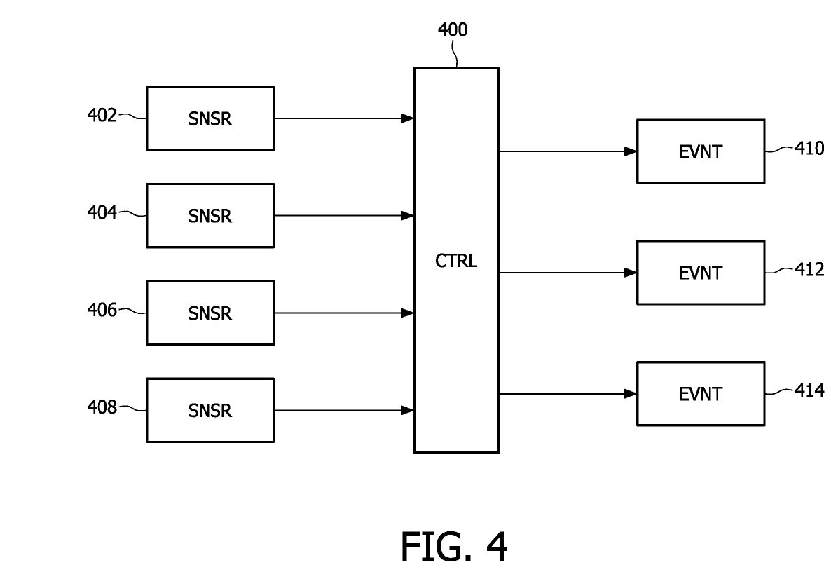

FIG. 4 shows a control system that is capable of implementing the method of initiating an event in a radiation imaging suite by a patient carrier as disclosed herein. Various sensors (SNSR) 402, 404, 406 and 408 located in different parts of a patient carrier detect physiological parameters such as patient motion, cardiac rate, respiratory rate, etc., or environmental parameters like room temperature, ambient light levels, etc., and feed their inputs to a control system (CTRL) 400. Based on the inputs from the various sensors and an algorithm that is capable of determining a next course of action, the control system 400 initiates one or more appropriate and corresponding events. For example, if a sensor detects that the temperature in the room where the patient is located is too low, it could relay a “low-temperature” signal to the control system 400, which could then send a signal to the air-conditioning unit to increase the temperature in the room. If another sensor detects an abnormal heart rate in the patient, it could send a warning signal to the control system 400, which could then transmit an emergency alert message to a caregiver located remotely. If the control system receives a signal that the patient is still in the patient carrier, for example from a weight sensor, while the signal from the heart rate sensor has dropped to zero, the control system may send an emergency alert signal to the caregiver. In addition to alerting the caregiver, the control system could also initiate other events simultaneously. For example, a request could be sent to the Intensive Care Unit requesting a bed to be blocked for the patient. Additional requests could be sent for readying appropriate equipment and medicines. Furthermore, the control system could also initiate a timer that keeps track of the exact time elapsed from the onset of the emergency alert signal. This information could be displayed at a convenient location near the patient so that the caregiver can ascertain at a glance, the gravity of the situation, and quickly decide on an appropriate treatment regime.

In one possible embodiment, the patient carrier could detect a physiological parameter of the patient and initiate an event that could control an environmental parameter. It is possible that the environmental parameter so controlled is sensed by another sensor in the patient carrier. For example, if the patient carrier detects vibrations from the patient that indicate that the patient is shivering, it could send a control signal to a temperature control system that could increase the temperature in the room. The change in temperature could be detected by another sensor to verify by how much the ambient temperature has actually increased in the vicinity of the patient.

The intelligence required by the control system to make decisions as given above could be provided by a suitable algorithm or suite of algorithms implemented in the form of computer programs. The control system may thus be implemented as a combination of hardware and software, for example in the form of a computer program running on a computer. The computer program may reside on a computer readable medium, for example a CD-ROM, a DVD, a floppy disk, a memory stick, a magnetic tape, a hard disk or any other tangible medium that is readable by a computer. The computer program may also be a downloadable program that is downloaded, or otherwise transferred to the computer, for example via the Internet. The computer program may be transferred to the computer via a transfer means such as an optical drive, a magnetic tape drive, a floppy drive, a USB or other computer port, an Ethernet port, etc.

The order in the described embodiments of the disclosed methods is not mandatory. A person skilled in the art may change the order of steps or perform steps concurrently using threading models, multi-processor systems or multiple processes without departing from the disclosed concepts.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The disclosed method can be implemented by means of hardware comprising several distinct elements, and by means of a suitably programmed computer. In the system claims enumerating several means, several of these means can be embodied by one and the same item of computer readable software or hardware. The mere fact that certain measures are recited in mutually different dependent claims does not indicate that a combination of these measures cannot be used to advantage.

1. A patient carrier for use in a radiation imaging suite, comprising:
at least one sensor configured to detect one or more parameters in a group of environmental parameters in the radiation imaging suite and physiological parameters of a patient positioned on the patient carrier, and
an event initiator arranged to initiate an event in the radiation imaging suite based on the one or more detected parameters.

2. The patient carrier of claim 1, wherein the initiated event is an audio and/or a visual trigger to the patient.

3. The patient carrier of claim 1, wherein the detected parameters include physical movement of one or more parts of the patient's body.

4. The patient carrier of claim 1, wherein the initiated event is an audio and/or a visual trigger to a remote location.

5. The patient carrier of claim 1, wherein the detected parameter is a physiological parameter of the patient and the initiated event involves adjusting an environmental parameter in the group of environmental parameters in the radiation imaging suite and physiological parameters of the patient, based on the detected physiological parameter.

6. A radiation imaging suite incorporating the patient carrier of claim 1, wherein the radiation imaging suite includes a positron emission tomography system and/or an X-ray computed tomography system.

7. A method of initiating an event in a radiation imaging suite by a patient carrier, wherein the patient carrier comprises at least one sensor, the method comprising:
detecting, using the at least one sensor, one or more parameters in a group of environmental parameters in the radiation imaging suite and physiological parameters of a patient positioned on the patient carrier, and
initiating an event in the radiation imaging suite based on the one or more detected parameters.

8. A computer program to enable a patient carrier to initiate an event in a radiation imaging suite, wherein the patient carrier comprises at least one sensor, the computer program comprising instructions to:
detect, using the at least one sensor, one or more parameters in a group of environmental parameters in the radiation imaging suite and physiological parameters of a patient positioned on the patient carrier, and
initiate an event in the radiation imaging suite based on the one or more detected parameters,
when the computer program is run on a computer.
